(19) United States
(12) Patent Application Publication
(10) Pub. No.: US 2025/0052116 A1
(43) Pub. Date: Feb. 13, 2025

(54) MULTIFUNCTION LADDER STRUCTURE

(71) Applicant: Formosa Saint Jose Corp., TAIPEI (TW)

(72) Inventor: Ming-Shun Yang, TAIPEI (TW)

(21) Appl. No.: 18/679,770

(22) Filed: May 31, 2024

Related U.S. Application Data
(63) Continuation-in-part of application No. 17/134,230, filed on Jan. 13, 2021.

(30) Foreign Application Priority Data
May 31, 2023 (TW) 112120610

(51) Int. Cl. E06C 7/50; E06C 7/16; E06C 7/42

(52) U.S. Cl. CPC E06C 7/50; E06C 7/16; E06C 7/42

(57) ABSTRACT

The present invention discloses multifunction ladder structures. The first embodiment includes a first ladder frame; a second ladder frame; and two combining assemblies that combine the second ladder frame with the first ladder frame. Another embodiment further includes an extension board, while a third embodiment includes two bolts set detachably fixed to the second ladder frame. With the implementation of the present invention, the multifunction ladder structures have the special benefit of being easy to install or operate; being able to insert and set firmly in between a tire and the wheel fender as a tire ladder; being able to stand firmly beside a car or other places as an A-shaped ladder; applying to tires of different size by adjusting the length of the foot rods; standing firmly on rough or inclined ground, roads or object surfaces; and with the adoption of the extension board, versatile applications are accomplished.

This application is a continuation-in-part application of prior application Ser. No. 17/134,230 filed Jan. 13, 2021.

### BACKGROUND OF THE INVENTION

### 1. Technical Field

The present invention relates to ladder structures, and more particularly, to multifunction ladder structures that can either be used as a tire ladder or as an A-shaped ladder and can be applied to a variety of types or models of cars.

### 2. Description of Related Art

Cars are widely used nowadays for transportation, everyday activities or in recreations, MPVs, SUVs or CUVs are getting more and more popular for choices of cars. With common characteristics and in nature, those vehicles are generally higher and are thus usually inconvenient when putting things on or fetching things from the top, or just attempting to clean it. Unpredictable dangers may sometimes unconsciously happen. A ladder, or more specifically, a tire ladder for car use then often provides an easy and popular solution.

While the tire ladders or ladders used on cars nowadays are mostly ladders of limited function that can either be used as a standing stairs or as a stairs leaning on the side of cars, and are either lacking structure stability in use or standing slipping or tumbling on rough or inclined roads. All those disadvantages generally lead to unpredictable danger and thus poor adoption to use, and eventually slow down the development of whole relating industry.

That results in the needs for innovative ladder structures that are easy to apply or operate; can be used as tire ladders putting stably on above a tire or in between the tire and its wheel fender; can be used as an A-shaped ladder standing firmly by a car or in other places; can be securely folded for transportation or storage; can be applied instantly on tires with different tread size and thus can be applied to almost all car types or car models; and more importantly, a ladder structure that can instantly stand firmly on rough or inclined ground, roads or object surfaces, thus provide not only a great innovation and improvements to car application and relating industries, but also a more convenient and safer use of cars.

### SUMMARY OF THE INVENTION

The present invention discloses multifunction ladder structures. The first embodiment includes a first ladder frame; a second ladder frame; and two combining assemblies that combine the second ladder frame with the first ladder frame. Another embodiment further includes an extension board, while a third embodiment includes two bolts set detachably fixed to the second ladder frame. With the implementation of the present invention, the multifunction ladder structures have the special benefit of being easy to install or operate; being able to insert and set firmly in between a tire and the wheel fender as a tire ladder; being able to stand firmly beside a car or other places as an A-shaped ladder; applying to tires of different size by adjusting the length of the foot rods; standing firmly on rough or inclined ground, roads or object surfaces; and with the adoption of the extension board, versatile applications are accomplished.

The present invention provides a multifunction ladder structure, comprising: a first ladder frame, includes: a top rod, which is a U-shaped tube; two first frame tubes, each being fixed firmly on an different end of said top rod and contains a foot rod on the other end; at least one first stepping unit, being connected firmly in between and joining said two first frame tubes; and two first buckling units, each being fixed firmly on one said first frame tube; a second ladder frame, includes: two second frame tubes, each being set in relative and next to a said first frame tube and contains a foot rod on one end; two second buckling units, each being fixed firmly on one said second frame tube; and at least one stepping unit, being connected firmly in between and joining said two second frame tubes; and two combining assemblies, each being connected to a meeting position of the top rod and a first frame tube, wherein the two combining assemblies combine the second ladder frame to the first ladder frame.

The present invention further provides a multifunction ladder structure, comprising: a first ladder frame, includes: a top rod, which is a U-shaped tube; two first frame tubes, each being fixed firmly on an different end of said top rod and contains a foot rod on the other end; at least one first stepping unit, being connected firmly in between and joining said two first frame tubes; and two first buckling units, each being fixed firmly on one said first frame tube; a second ladder frame, includes: two second frame tubes, each being set in relative and next to a said first frame tube and contains a foot rod on one end; two second buckling units, each being fixed firmly on one said second frame tube; and at least one stepping unit, being connected firmly in between and joining said two second frame tubes; two combining assemblies, each being connected to a meeting position of the top rod and a first frame tube, wherein the two combining assemblies combine the second ladder frame to the first ladder frame; and an extension board, set hooked to said first ladder frame at a first edge and detachably linked to said second frame tubes with two linking means.

The present invention further provides a multifunction ladder structure, comprising: a first ladder frame, includes: a top rod, which is a U-shaped tube; two first frame tubes, each being fixed firmly on an different end of said top rod and contains a foot rod on the other end; at least one first stepping unit, being connected firmly in between and joining said two first frame tubes; and two first buckling units, each being fixed firmly on one said first frame tube; a second ladder frame, includes: two second frame tubes, each being set in relative and next to a said first frame tube and contains a foot rod on one end; two second buckling units, each being fixed firmly on one said second frame tube; and at least one stepping unit, being connected firmly in between and joining said two second frame tubes; two combining assemblies, each being connected to a meeting position of the top rod and a first frame tube, wherein the two combining assemblies combine the second ladder frame to the first ladder frame; and two bolts, each set detachably fixed to a said second frame tubes.

Implementation of the present invention at least involves the following inventive steps:
1. Easy to set up or to operate.
2. Can be used as a tire ladder putting stably on above a tire or in between the tire and its wheel fender.
3. Can be used as an A-shaped ladder standing firmly by a car or in other places.
4. The multifunction ladder structures can be securely folded for transportation or storage.
5. Each foot rod can be adjusted separately that makes multifunction ladder structures being able to be applied instantly on tires with different tread size and thus can be applied to almost all car types or car models.
6. With length adjustable foot rods, the multifunction ladder structures can stand firmly on rough or inclined ground, roads or object surfaces.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic view of a multifunction ladder structure according to an embodiment of the present invention.

FIG. 2 is a schematic view of a multifunction ladder structure according to another embodiment of the present invention.

FIG. 3 is a schematic view of a multifunction ladder structure with a bolt on each second frame tube according to an embodiment of the present invention.

FIG. 4 is a schematic view of a multifunction ladder structure according to another embodiment of the present invention.

FIG. 5 is a schematic view of a multifunction ladder structure with an extension board and a bolt on each second frame tube according to an embodiment of the present invention.

FIG. 6A is a schematic view of a multifunction ladder structure with adjustable foot rods according to an embodiment of the present invention.

FIG. 6B is a schematic view of a multifunction ladder structure with adjustable foot rods according to another embodiment of the present invention.

FIG. 6C is a schematic view of a multifunction ladder structure with adjustable foot rods according to another embodiment of the present invention.

FIG. 7A is a schematic view of a multifunction ladder structure with a fit rod according to an embodiment of the present invention.

FIG. 7B is a schematic view of a multifunction ladder structure with a fit rod according to another embodiment of the present invention.

FIG. 7C is a schematic view of a multifunction ladder structure with a fit rod according to another embodiment of the present invention.

FIG. 8A is a schematic view of a multifunction ladder structure with a fit rod and a lock piece locking the multifunction ladder structure to a backdoor hook of a car according to an embodiment of the present invention.

FIG. 8B is a schematic view of a multifunction ladder structure with a fit rod and a lock piece locking the multifunction ladder structure to a backdoor hook of a car according to another embodiment of the present invention.

FIG. 8C is a schematic view of a multifunction ladder structure with a fit rod and a lock piece locking the multifunction ladder structure to a backdoor hook of a car according to another embodiment of the present invention.

FIG. 9A is a schematic view of two multifunction ladder structures being connected together at the first frame tubes according to an embodiment of the present invention.

FIG. 9B is a schematic view of two multifunction ladder structures being connected together at the first frame tubes according to another embodiment of the present invention.

FIG. 9C is a schematic view of two multifunction ladder structures being connected together at the first frame tubes according to another embodiment of the present invention.

FIG. 10A is a schematic view of two multifunction ladder structures being connected together and a board is set on the connected first frame tubes according to an embodiment of the present invention.

FIG. 10B is a schematic view of two multifunction ladder structures being connected together and a board is set on the connected first frame tubes according to another embodiment of the present invention.

FIG. 10C is a schematic view of two multifunction ladder structures being connected together and a board is set on the connected first frame tubes according to another embodiment of the present invention.

FIG. 11A is a schematic view of two multifunction ladder structures being connected together and a stove shelf is hung on the connected first frame tubes according to an embodiment of the present invention.

FIG. 11B is a schematic view of two multifunction ladder structures being connected together and a stove shelf is hung on the connected first frame tubes according to another embodiment of the present invention.

FIG. 11C is a schematic view of two multifunction ladder structures being connected together and a stove shelf is hung on the connected first frame tubes according to another embodiment of the present invention.

### DETAILED DESCRIPTION OF THE EMBODIMENTS OF THE INVENTION

Embodiments together with illustrating graphs reference are provided hereafter for further understanding and recognizing of the realization of the present invention.

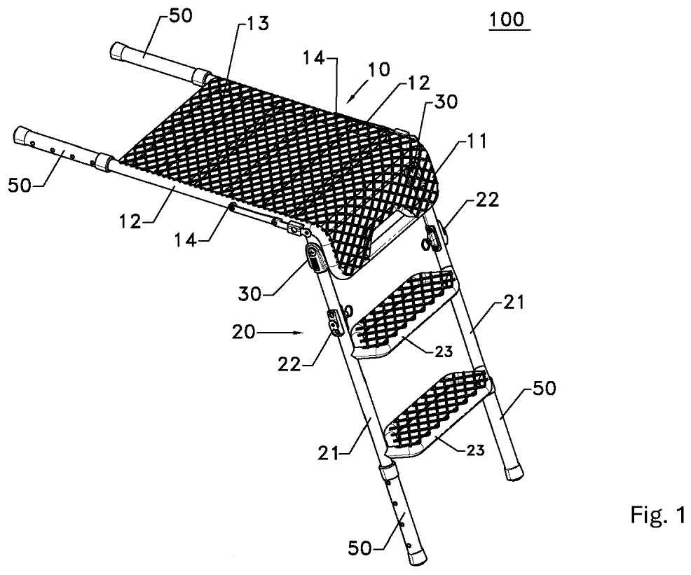

Please refer to FIG. 1, in an embodiment of the present invention, is a multifunction ladder structure 100 that comprises a first ladder frame 10; a second ladder frame 20; and two combining assemblies 30.

Please refer to FIG. 1, the first ladder frame 10 of the multifunction ladder structure 100 includes a top rod 11, two first frame tubes 12, at least one first stepping unit 13, and two first buckling units 14. Wherein said top rod 11, being a U-shaped tube, can be made of metal tube, alloy tube or a tube made of one of durable polymer materials.

As can be seen in FIG. 1, the first frame tubes 12 that are aligned to a same direction are formed in a way that each first frame tube 12 connects in one end to a different end of the top rod 11, and contains a foot rod 50 on the other end. Further, an included angle is also formed between each of the first frame tubes 12 and the U-shaped top rod 11.

As for the forming material of the first frame tubes 12, same forming material that forms the U-shaped top rod 11 can be chosen, and in a performing embodiment, the first frame tubes 12 can be integrated in one piece together with the top rod 11. And at the same time, the two first frame tubes 12 can be formed aligned parallel to each other, or aligned nearly parallel to each other.

As shown in FIG. 1, the distance between the two first frame tubes 12 can be formed that with the foot rods 50 pointing at a tire, the first ladder frame 10 inserts freely in the space in between the tire and its wheel fender and rest on the tire.

Please refer again to FIG. 1, at least one first stepping unit 13 is being connected firmly in between and joins the two first frame tubes 12, wherein the first stepping unit 13 can be a stepping pedal formed by a sturdy mesh tread, a sturdy tread pedal, a sturdy tread pedal with plural through holes, or at least two tubes placed in parallel to each other to form a sturdy tread surface for stepping on. Further, for safer use in applications, the first stepping unit 13 can be formed of an anti-slip material.

As also shown in FIG. 1, the first buckling units 14 are formed such that each being connected to or fixed firmly on a first frame tube 12. Said first buckling units 14 can be a linking rod, a hook, a bendable linking rod, a bendable hook, or a webbing ribbon with at least a buckle or a buttonhole.

Please refer again to FIG. 1, the second ladder frame 20 of the multifunction ladder structure 100 includes two second frame tubes 21, two second buckling units 22, and at least one stepping unit 23.

As shown in FIG. 1, the second frame tubes 21 are set corresponding to the first frame tubes 12 and can also be sturdy tubes. The second frame tubes 21 can also be aligned parallel or nearly parallel to each other. Further, a foot rod 50 is being connected at one end of each second frame tube 21.

As for the thickness or size of each second frame tube 21, same thickness value or size as the corresponding first frame tube 12 can be chosen. While the distance of the two second frame tubes 21 at any position can also be chosen to be same as the distance of the two first frame tubes 12 at a corresponding position.

As also shown in FIG. 1, the second buckling units 22 are formed such that each second buckling unit 22 being fixed firmly on a second frame tube 21, and in the multifunction ladder structure 100, each said second buckling unit 22 is either linked together with or detached from a corresponding first buckling unit 14.

That is to say, the second ladder frame 20 can be further connected with the first ladder structure 10 with the two second buckling units 22 being linking together with the two corresponding first buckling units 14.

Please refer again to FIG. 1, the stepping unit 23, being a tube connected firmly in between and joining the two second frame tubes 21, can be used as a stepping stair of the second ladder frame 20.

Please refer to FIG. 1, the two combining assemblies 30 of the multifunction ladder structure 100, each being connected to a meeting position of the top rod 11 and a first frame tube 12, combine the second ladder frame 20 to the first ladder frame 10 in a way that the second ladder frame 20 being either rotating at the combining assemblies 30 relative to the first ladder frame 10, or the second ladder frame 20 being connected firmly on the first ladder frame 10 at the combining assemblies 30.

As such, the multifunction ladder structure 100 is formed when combining the second ladder frame 20 with the first ladder frame 10 by the combining assemblies 30. The second ladder frame 20 is then firmly fixed after rotating at the combining assemblies 30 with a required included angle with the first ladder frame 10 to make the multifunction ladder structure 100 a tire ladder or an A-shaped ladder.

Wherein the combining method can be that the second ladder frame 20 is riveted or screwed to the combining assemblies 30 and is able to rotate at the combining assemblies 30 or is securely fixed at the combining assemblies 30 to the first ladder frame 10.

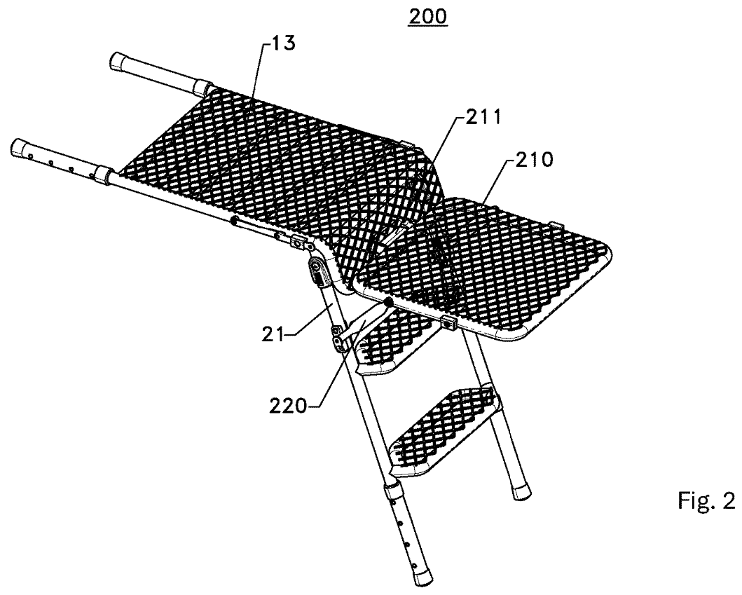

Next, please refer to FIG. 2, is an embodiment of a multifunction ladder structure 200, comprising: a multifunction ladder structure 100 and an extension board 210. The extension board 210 is set hooked to the first ladder frame 10 at a first edge 211 and detachably linked to the second frame tubes 21 with two linking means 220.

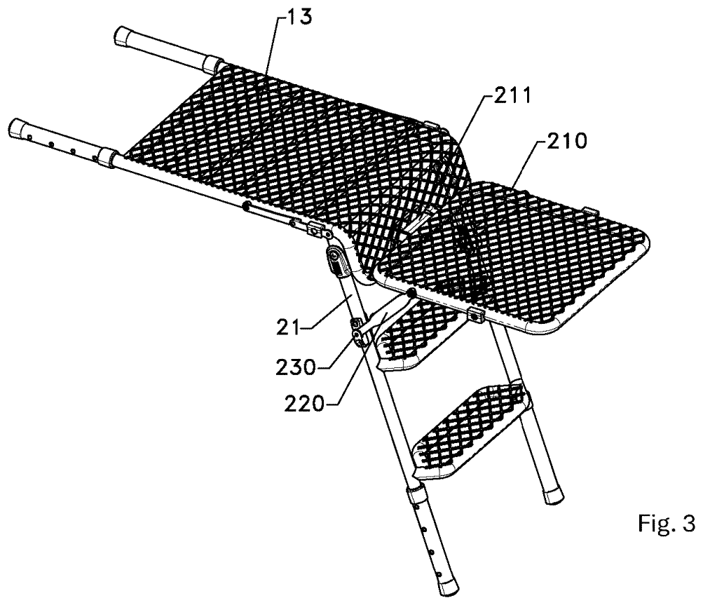

Then as shown in FIG. 3, each of the linking means 220 can be detachably fixed to a second frame tube 21 with a bolt 230. With the connection using the bolt 230, benefits can be achieved, such as, safer connection of the first ladder frame 10 and the second ladder frame 20 can be achieved; when the end portion of the bolt 230 is painted, proper connection can be assured; the extension board can be properly supported to increase the durable weight; and quick transforming between ladder application and tire table application.

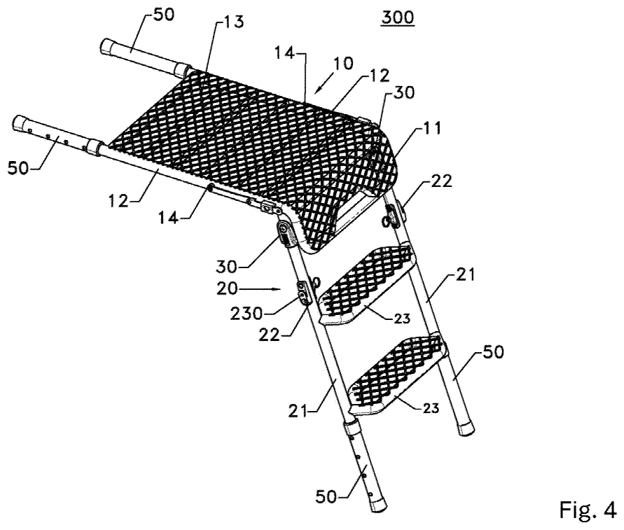

Please refer to FIG. 4, is another embodiment of a multifunction ladder structure 300, comprising: a multifunction ladder structure 100 and two bolts 230, each bolt 230 is set detachably fixed to a said second frame tubes 21.

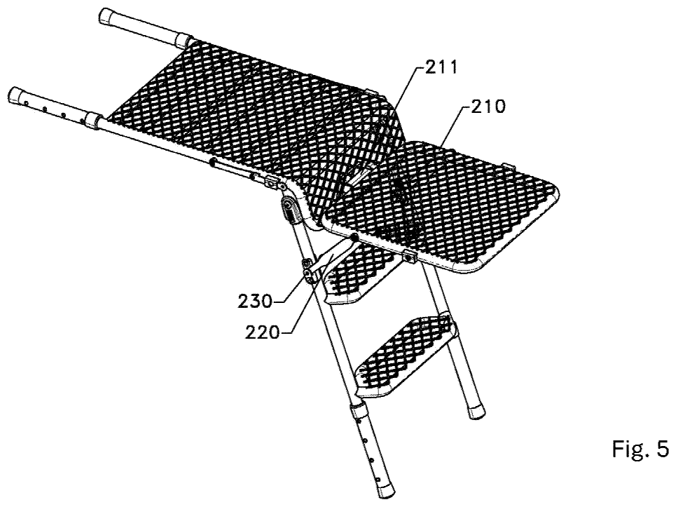

As shown in FIG. 4 and FIG. 5, an extension board 210 can be set hooked to the first ladder frame 10 at a first edge 211 and detachably linked to said second frame tubes 21 with two linking means 220, wherein each linking means 220 is detachably fixed to a second frame tube 21 by a bolt 230.

The benefit of the extension board 210 is to provide additional table area, while the benefits of using bolts 230 are as discussed previously.

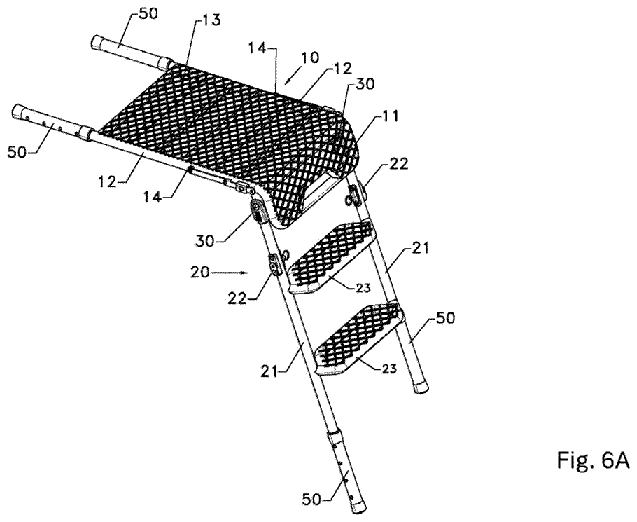

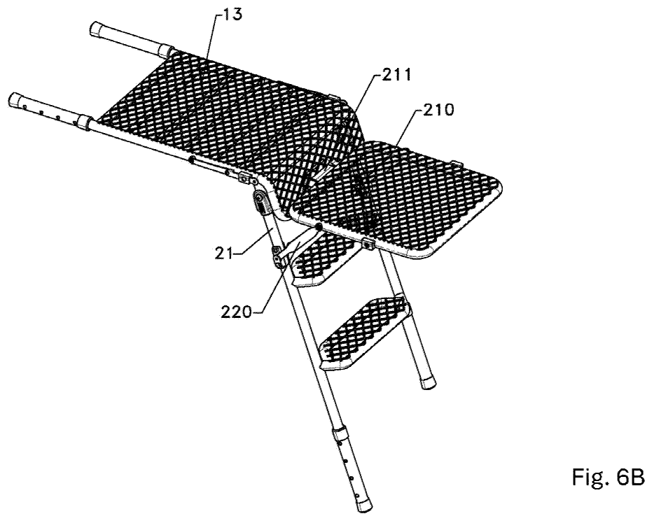

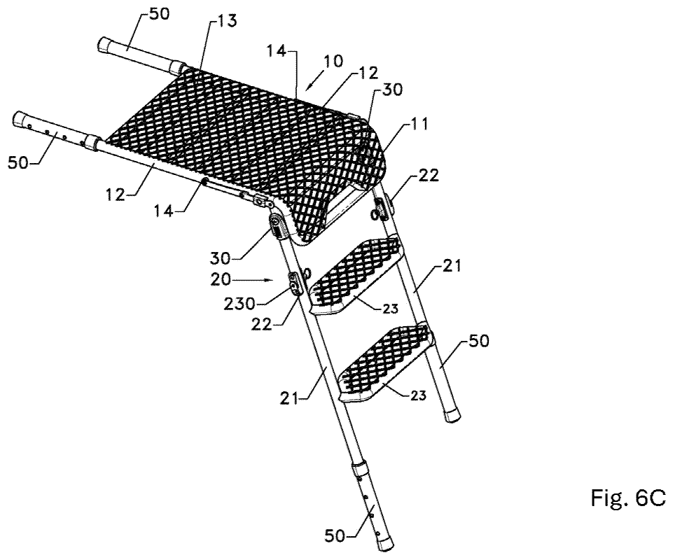

Please refer to FIG. 6A, FIG. 6B and FIG. 6C, each foot rod 50 of the multifunction ladder structure 100, or of the multifunction ladder structure 200, or of the multifunction ladder structure 300, can be extendable in length. Especially, when each foot rod 50 is independently extending or remaining still in a certain position in a first frame tube 12 or in a second frame tube 21, making the multifunction ladder structure 100, the multifunction ladder structure 200 or the multifunction ladder structure 300 capable of standing firmly even on rough or inclined ground, roads or object surfaces; and applying better on tires of different size or with different tread size, and thus can applies to almost all car types or models.

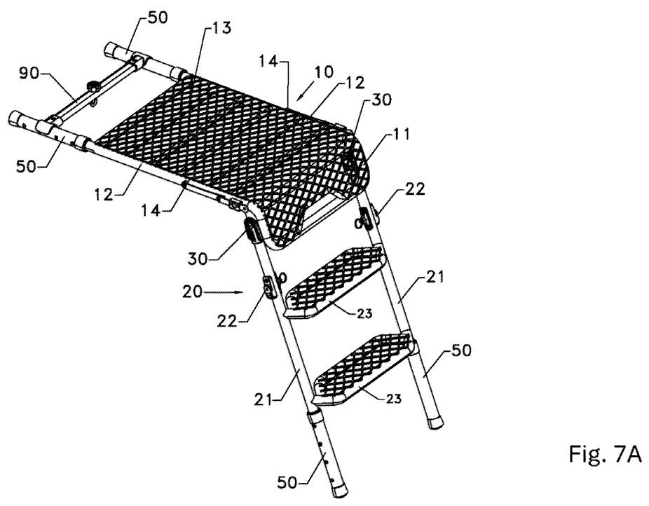

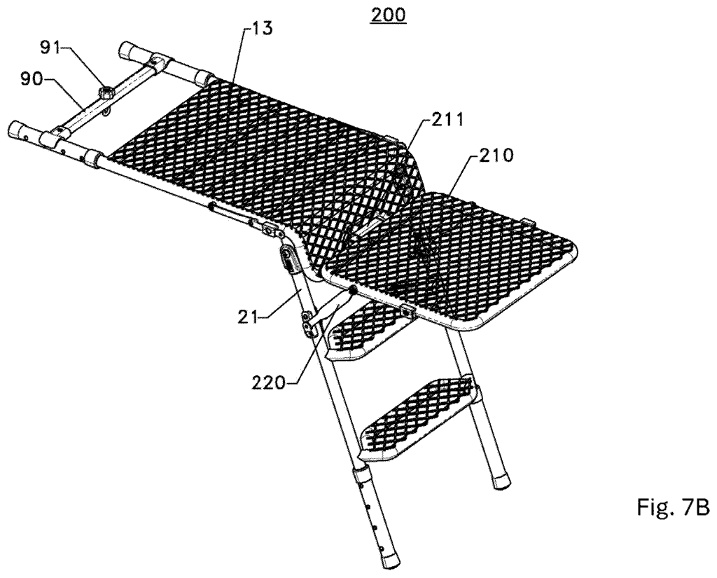

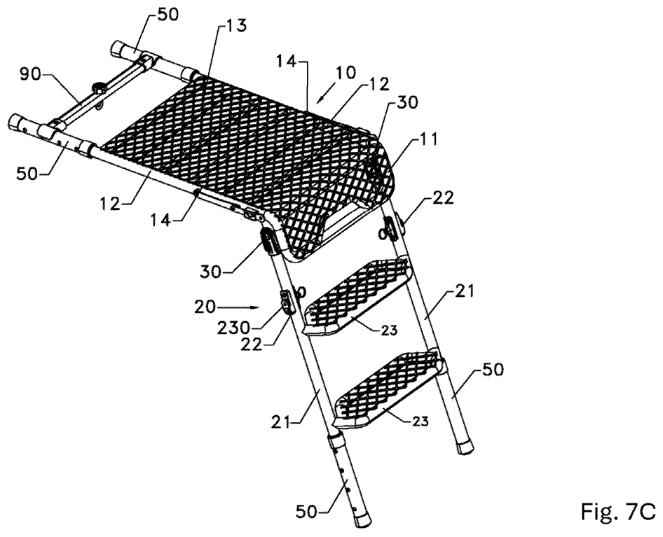

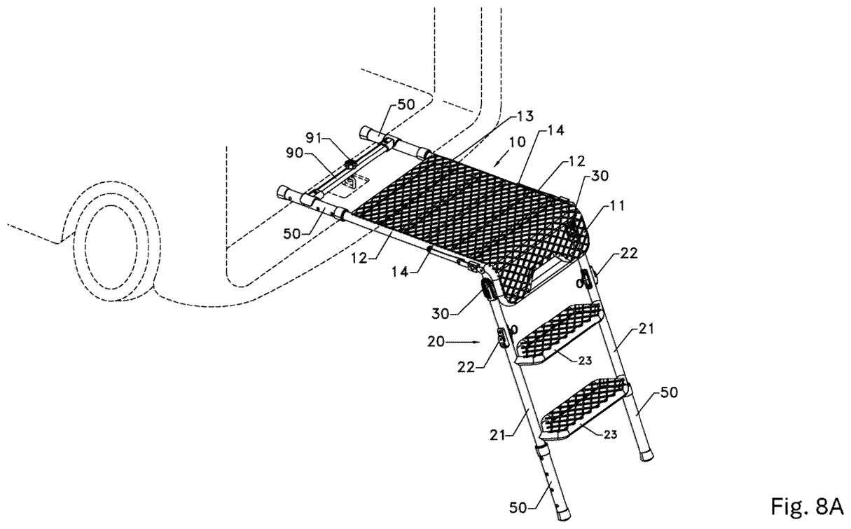

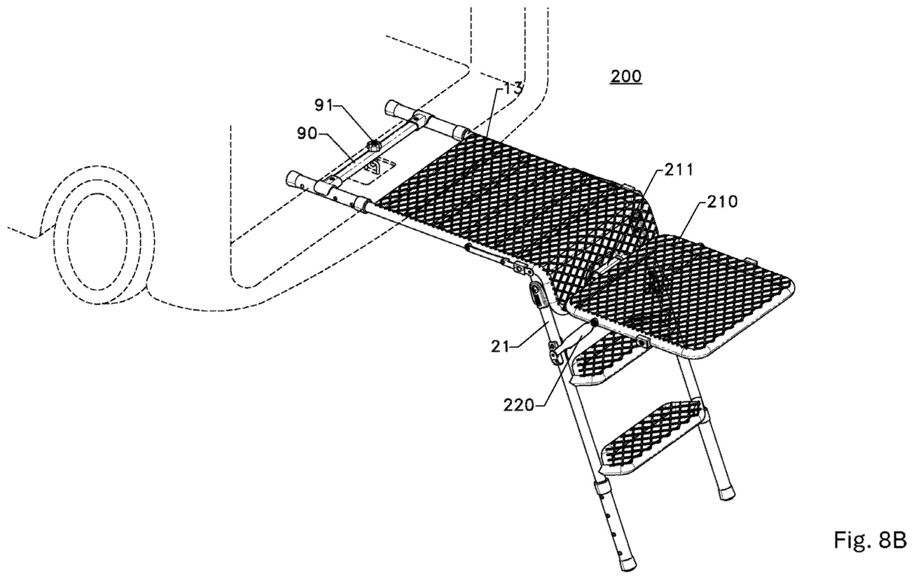

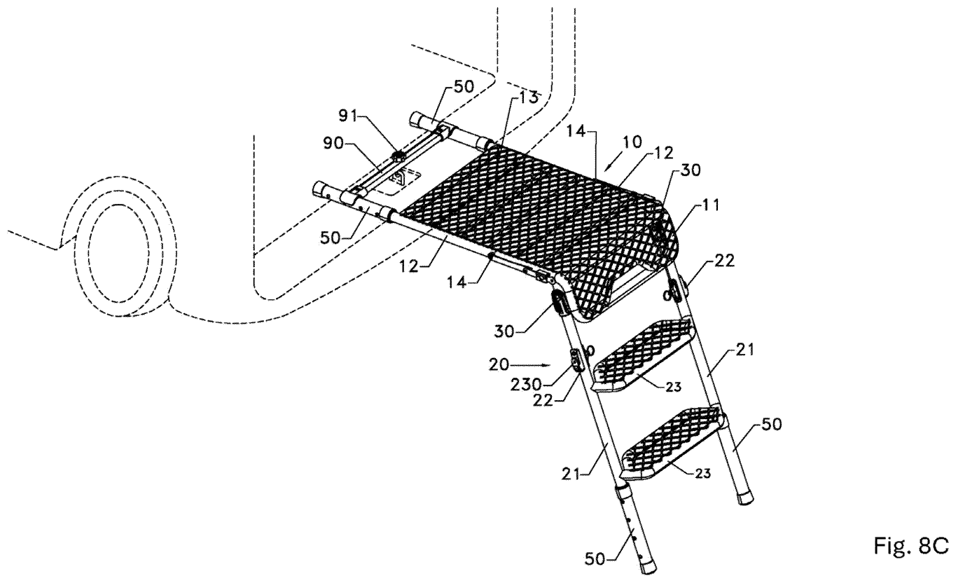

Next, please refer to FIG. 7A to FIG. 8C, the multifunction ladder structure 100, the multifunction ladder structure 200 or the multifunction ladder structure 300, each can further contain a fit rod 90 detachably fixed across the foot rods 50 of the first frame tubes 12. Then the fit rod 90 can be locked securely on a backdoor hook of a car with a lock piece 91.

With the locking from the fit rod 90 that is fixed across the foot rods 50 of the first frame tubes 12, to the backdoor hook of a car, the whole multifunction ladder structure 100 or the multifunction ladder structure 200 or the multifunction ladder structure 300 is locked to the backdoor hook of a car. Together with proper choice of the length of the foot rods 50 of the second frame tubes 21, the multifunction ladder structure 100 or the multifunction ladder structure 200 or the multifunction ladder structure 300 becomes a convenient table extends out from back of the car.

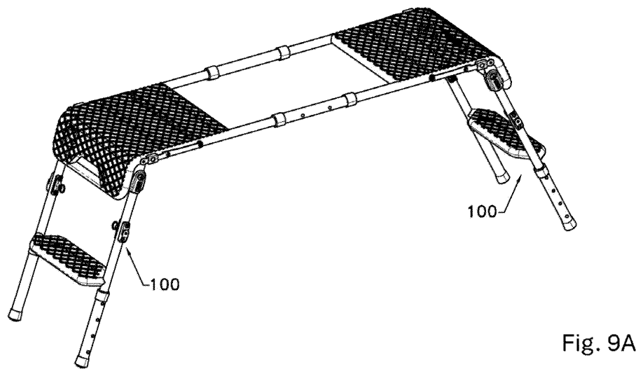

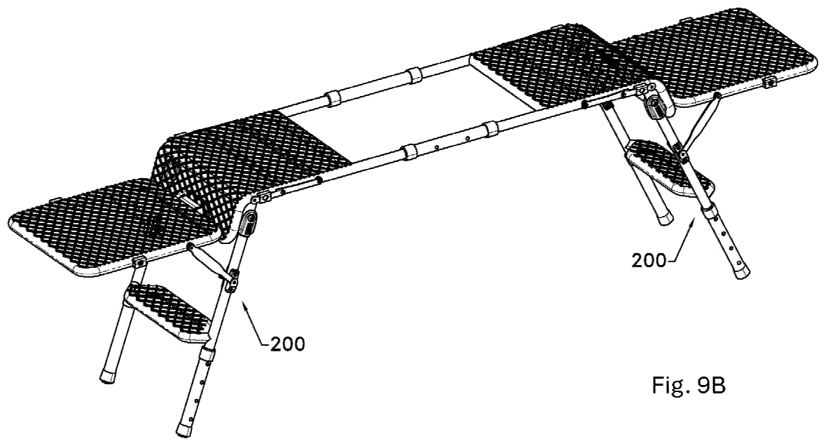

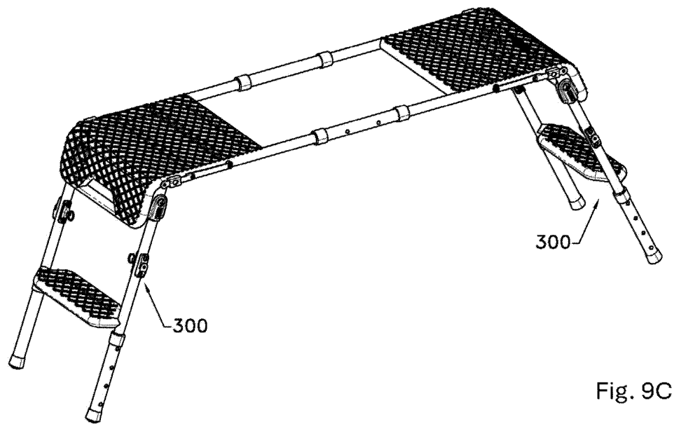

While as shown in FIG. 9A to FIG. 9C, in two multifunction ladder structures 100 or multifunction ladder structures 200 or multifunction ladder structures 300, the foot rods 50 of the first frame tubes 12 can be removed. Then the two multifunction ladder structures 100 or multifunction ladder structures 200 or multifunction ladder structures 300 are connected together at the first frame tubes 12.

In the embodiments as shown in FIG. 9A to FIG. 9C, the two multifunction ladder structures 100 or the two multifunction ladder structures 200 or the two multifunction ladder structures 300 connected together then stand with the foot rods 50 of the second frame tubes 21 as an extended table.

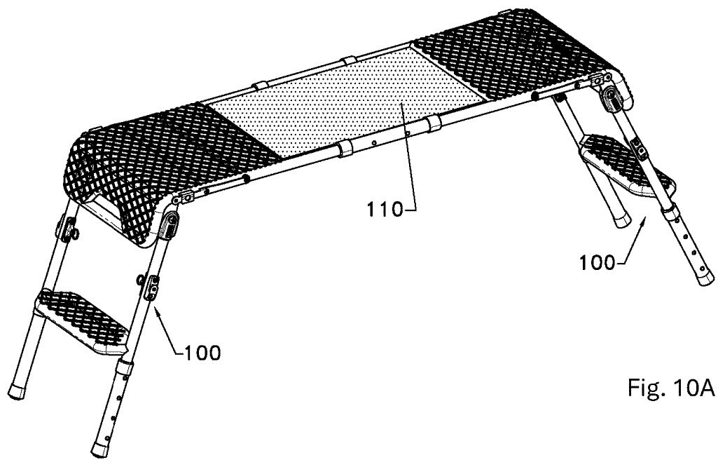

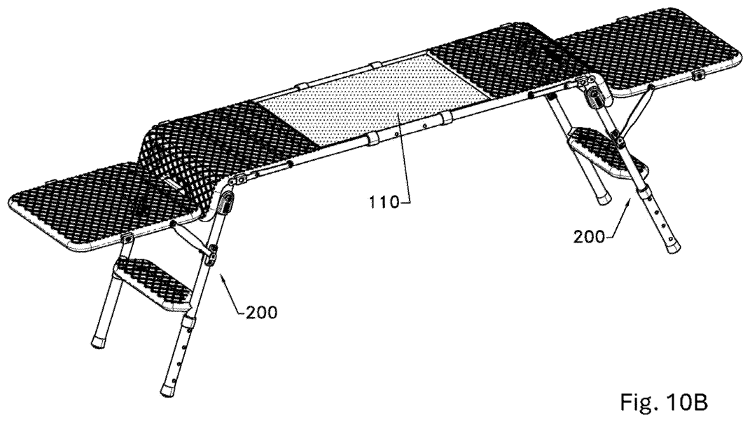

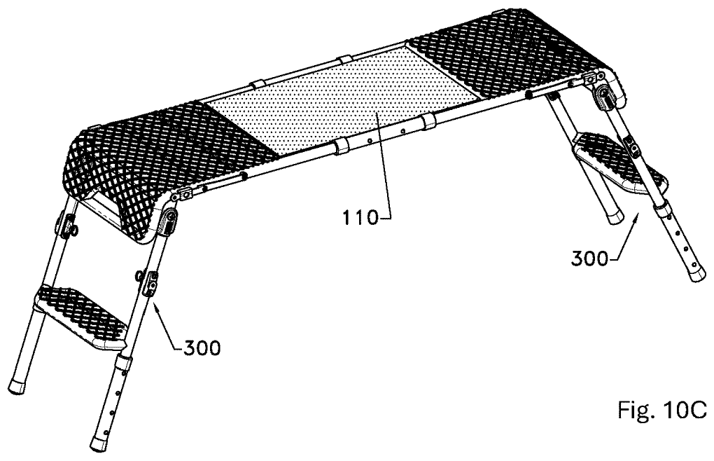

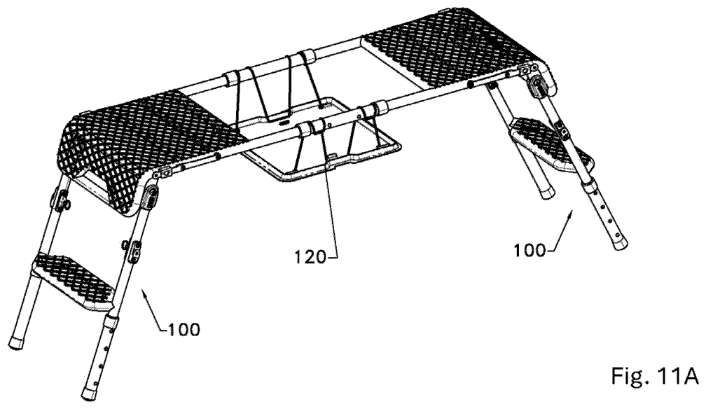

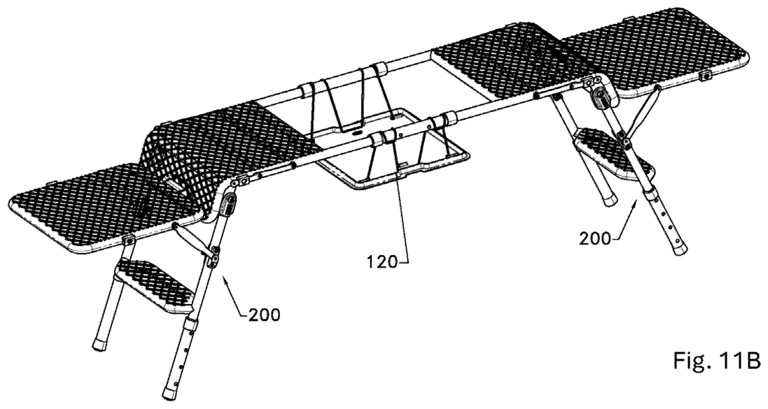

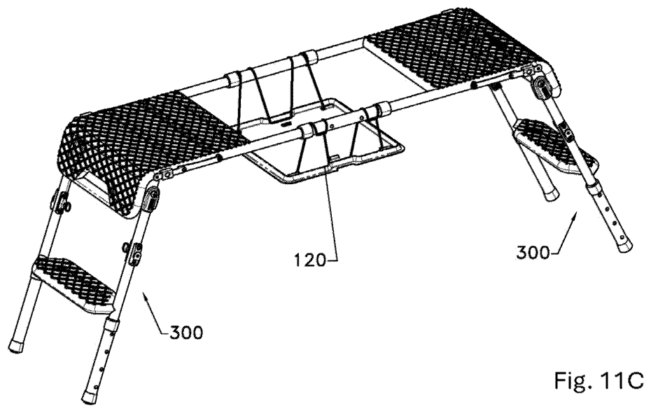

Further as shown in FIG. 10A to FIG. 11C, a board 110 or a stove shelf 120 can further be set or hung on the connected first frame tubes 12 for extensive applications.

In conclusion, as shown in the embodiments and in the illustrating figures FIG. 1 to FIG. 11C, with the special improved structural characteristics, multiple improvements as follows, which cannot be achieved by known existing solutions, can be achieved by the multifunction ladder structure 100 or multifunction ladder structure 200 or multifunction ladder structure 300 of the present invention: being easy to set up or to operate; can be used as a tire ladder putting stably on above a tire or in between the tire and its wheel fender; can be used as an A-shaped ladder standing firmly by a car or in other places; and each of the foot rods 50 can be adjusted separately to make the multifunction ladder structure 100 or multifunction ladder structure 200 or multifunction ladder structure 300 being able to be applied instantly on tires with different tread size and thus can be applied to almost all car types or models, and being able to stand further firmly on rough or inclined ground, roads or object surfaces; and thus increase the practicality and convenience of using of the multifunction ladder structure 100 or multifunction ladder structure 200 or multifunction ladder structure 300.

The embodiments described above are intended only to demonstrate the technical concept and features of the present invention to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A multifunction ladder structure, comprising:
a first ladder frame, includes:
a top rod, which is a U-shaped tube;
two first frame tubes, each being fixed firmly on an different end of said top rod and contains a foot rod on the other end;
at least one first stepping unit, being connected firmly in between and joining said two first frame tubes; and
two first buckling units, each being fixed firmly on one said first frame tube;
a second ladder frame, includes:
two second frame tubes, each being set in relative and next to a said first frame tube and contains a foot rod on one end;
two second buckling units, each being fixed firmly on one said second frame tube; and
at least one stepping unit, being connected firmly in between and joining said two second frame tubes; and
two combining assemblies, each being connected to a meeting position of the top rod and a first frame tube, wherein the two combining assemblies combine the second ladder frame to the first ladder frame.

2. A multifunction ladder structure, comprising:
a first ladder frame, includes: a top rod, which is a U-shaped tube; two first frame tubes, each being fixed firmly on an different end of said top rod and contains a foot rod on the other end; at least one first stepping unit, being connected firmly in between and joining said two first frame tubes; and two first buckling units, each being fixed firmly on one said first frame tube;
a second ladder frame, includes: two second frame tubes, each being set in relative and next to a said first frame tube and contains a foot rod on one end; two second buckling units, each being fixed firmly on one said second frame tube; and at least one stepping unit, being connected firmly in between and joining said two second frame tubes;
two combining assemblies, each being connected to a meeting position of the top rod and a first frame tube, wherein the two combining assemblies combine the second ladder frame to the first ladder frame; and
an extension board, set hooked to said first ladder frame at a first edge and detachably linked to said second frame tubes with two linking means.

3. The multifunction ladder structure according to claim 2, wherein each said linking means is detachably fixed to a said second frame tubes with a bolt.

4. A multifunction ladder structure, comprising:
a first ladder frame, includes: a top rod, which is a U-shaped tube; two first frame tubes, each being fixed firmly on an different end of said top rod and contains a foot rod on the other end; at least one first stepping unit, being connected firmly in between and joining said two first frame tubes; and two first buckling units, each being fixed firmly on one said first frame tube;
a second ladder frame, includes: two second frame tubes, each being set in relative and next to a said first frame tube and contains a foot rod on one end; two second buckling units, each being fixed firmly on one said second frame tube; and at least one stepping unit, being connected firmly in between and joining said two second frame tubes;
two combining assemblies, each being connected to a meeting position of the top rod and a first frame tube, wherein the two combining assemblies combine the second ladder frame to the first ladder frame; and
two bolts, each set detachably fixed to a said second frame tubes.

5. The multifunction ladder structure according to claim 4, wherein an extension board is being set hooked to the first ladder frame at a first edge and detachably linked to said second frame tubes with two linking means, wherein each linking means is detachably fixed to a second frame tube by a said bolt.

6. The multifunction ladder structure according to claim 1, wherein each said foot rod is extendable in length.

7. The multifunction ladder structure according to claim 2, wherein each said foot rod is extendable in length.

8. The multifunction ladder structure according to claim 4, wherein each said foot rod is extendable in length.

9. The multifunction ladder structure according to claim 1, further contains a fit rod, detachably fixed across the foot rods of said first frame tubes.

10. The multifunction ladder structure according to claim 2, further contains a fit rod, detachably fixed across the foot rods of said first frame tubes.

11. The multifunction ladder structure according to claim 4, further contains a fit rod, detachably fixed across the foot rods of said first frame tubes.

12. The multifunction ladder structure according to claim 9, wherein said fit rod further contains a lock piece, said lock piece lock the multifunction ladder structure to a backdoor hook of a car.

13. The multifunction ladder structure according to claim 10, wherein said fit rod further contains a lock piece, said lock piece lock the multifunction ladder structure to a backdoor hook of a car.

14. The multifunction ladder structure according to claim 11, wherein said fit rod further contains a lock piece, said lock piece lock the multifunction ladder structure to a backdoor hook of a car.

15. The multifunction ladder structure according to claim 1, wherein in two multifunction ladder structures, the foot rods of said first frame tubes are removed, and said two multifunction ladder structures are being connected together at the first frame tubes.

16. The multifunction ladder structure according to claim 2, wherein in two multifunction ladder structures, the foot rods of said first frame tubes are removed, and said two multifunction ladder structures are being connected together at said first frame tubes.

17. The multifunction ladder structure according to claim 4, wherein in two multifunction ladder structures, the foot rods of said first frame tube are removed, and said two multifunction ladder structures are being connected together at said first frame tubes.

18. The multifunction ladder structure according to claim 15, wherein a board or a stove shelf is set or hung on the connected first frame tubes.

19. The multifunction ladder structure according to claim 16, wherein a board or a stove shelf is set or hung on the connected first frame tubes.

20. The multifunction ladder structure according to claim 17, wherein a board or a stove shelf is set or hung on the connected first frame tubes.
